(19) United States
(12) Patent Application Publication
(10) Pub. No.: US 2026/0020133 A1
(43) Pub. Date: Jan. 15, 2026

(54) METHOD AND LASER SYSTEM FOR GENERATING SECONDARY RADIATION

(71) Applicant: TRUMPF Laser AG, Schramberg (DE)

(72) Inventors: Torsten Mans, Aachen (DE); Marc Sailer, Schramberg (DE); Max Kahmann, Nufringen (DE); Daniel Flamm, Ludwigsburg (DE)

(21) Appl. No.: 19/336,539

(22) Filed: Sep. 23, 2025

Related U.S. Application Data
(63) Continuation of application No. PCT/EP2024/058145, filed on Mar. 26, 2024.

(30) Foreign Application Priority Data
Mar. 27, 2023 (DE) 10 2023 107 701.5

(51) Int. Cl. H05G 2/00

(52) U.S. Cl. CPC H05G 2/0088; H05G 2/0084

(57) ABSTRACT

A method for generating secondary radiation includes providing a target material in a target region, and applying a pulse sequence comprising laser pulses to the target material in the target region. Interaction of the target material with the pulse sequence generates secondary radiation. The pulse sequence includes a prepulse and a main pulse trailing the prepulse. A pulse energy of the prepulse is between 2 μJ und 200 μJ. A pulse duration of the prepulse is between 200 fs and 5 ps. A pulse energy of the main pulse is between 2 mJ and 50 mJ. A pulse duration of the main pulse is between 15 fs and 300 fs. A pulse time interval between the prepulse and the main pulse is between 1 ps and 1 ns.

### CROSS REFERENCE TO RELATED APPLICATIONS

This application is a continuation of International Application No. PCT/EP2024/058145 (WO 2024/200461 A1), filed on Mar. 26, 2024, and claims benefit to German Patent Application No. DE 10 2023 107 701.5, filed on Mar. 27, 2023. The aforementioned applications are hereby incorporated by reference herein.

### FIELD

Embodiments of the present invention relate to a method and a laser system for generating secondary radiation.

### BACKGROUND

A method for generating EUV light is known from US 2018317309 A1, wherein a droplet of target material is formed by irradiation with a first prepulse laser beam, a seed plasma is generated by irradiation of the formed droplet with a second prepulse laser beam and EUV light is generated by heating the seed plasma with a main pulse laser beam.

US 2018206318 A1 discloses a modular plasma X-ray system comprising a liquid metal flow system enclosed in a low-pressure chamber, wherein the flow system contains a liquid metal and wherein a metal target irradiable by laser pulses is formed at at least one location on the liquid metal, a circulation pump within the liquid metal flow system for circulating the liquid metal, a laser pulse emitter that is configured to emit laser pulses through a laser window into the chamber, a focusing optical unit located between the emitter and the metal target, wherein the focusing optical unit guides the laser pulses such that they strike the metal target at a target location in order to form X-ray pulses, and an X-ray window that is positioned within the chamber and through which the X-ray pulses leave the chamber.

An EUV radiation generation device is known from WO 2014044392 A1, comprising a vacuum chamber in which a target material can be arranged at a target position for generating EUV radiation, and a beam guidance chamber for guiding a laser beam from a driver laser device in the direction of the target position. An intermediate chamber is provided, which is mounted between the vacuum chamber and the beam guidance chamber, a first window sealing the intermediate chamber in a gas-tight manner for the entry of the laser beam from the beam guidance chamber, and a second window sealing the intermediate chamber in a gas-tight manner for the emergence of the laser beam into the vacuum chamber.

### SUMMARY

Embodiments of the present invention provide a method for generating secondary radiation. The method includes providing a target material in a target region, and applying a pulse sequence comprising laser pulses to the target material in the target region. Interaction of the target material with the pulse sequence generates secondary radiation. The pulse sequence includes a prepulse and a main pulse trailing the prepulse. A pulse energy of the prepulse is between 2 μJ und 200 μJ. A pulse duration of the prepulse is between 200 fs and 5 ps. A pulse energy of the main pulse is between 2 mJ and 50 mJ. A pulse duration of the main pulse is between 15 fs and 300 fs. A pulse time interval between the prepulse and the main pulse is between 1 ps and 1 ns.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an exemplary embodiment of a laser system;

FIG. 2a, FIG. 2b and FIG. 2c show a first example for generating secondary radiation, wherein an indentation is generated in the target material by means of a pulse train made up of prepulses according to some embodiments; and

FIG. 3a, FIG. 3b and FIG. 3c show a further example for generating secondary radiation, wherein nanoparticles are generated in the region of the surface of the material by means of a prepulse according to some embodiments.

### DETAILED DESCRIPTION

Embodiments of the present invention provide a method and a laser system that can allow for secondary radiation to be generated with increased efficiency.

According to embodiments of the invention, a target material is provided in a target region, a pulse sequence made up of laser pulses is applied to the target material in the target region, wherein interaction of the target material with the pulse sequence generates secondary radiation, wherein the pulse sequence has a prepulse and a main pulse trailing the prepulse, a pulse energy of the prepulse is between 2 μJ und 200 μJ and a pulse duration of the prepulse is between 200 fs and 5 ps, a pulse energy of the main pulse is between 2 mJ and 50 mJ and a pulse duration of the main pulse is between 15 fs and 300 fs and wherein a pulse time interval between the prepulse and the main pulse is between 1 ps and 1 ns.

Nanometer-sized particles can be released from the target material through the interaction of the prepulse with the target material. These particles consisting of target material are referred to here as nanoparticles and are positioned in the region of a surface of the original target material where they were released due to the application of the prepulse. When the main pulse arrives at the target material, an additional interaction of the main pulse with the nanoparticles occurs. It has been shown that the preparation of the target material by means of the prepulse and the nanoparticles generated in the process improve the efficiency of the interaction of the main pulse with the target material and in particular its absorption on the target material. This allows for a particularly efficient generation of secondary radiation.

The interaction of the laser pulses of the pulse sequence with the target material is or comprises in particular at least in part an absorption of the laser pulses by the target material. In particular, the laser pulses of the pulse sequence are absorbed at least in part by the target material.

The circumstance that the main pulse trails the prepulse means that the prepulse strikes the target material chronologically prior to the main pulse. The prepulse therefore strikes the target material first, followed by the main pulse.

The pulse sequence can have multiple prepulses preceding the main pulse or a pulse train made up of multiple prepulses preceding the main pulse. In this regard, the prepulses have the characteristics of the prepulse sequence specified in the claims as mentioned above and/or below. In particular, the respective prepulses of the pulse sequence then contribute to the formation of nanoparticles or cause the formation of nanoparticles.

The secondary radiation generated by means of the method according to embodiments of the invention is in particular electromagnetic radiation with a quantum energy between 0.5 keV and 100 keV and preferably between 5 keV and 50 keV. In particular, the method according to embodiments of the invention is suitable for generating electromagnetic radiation with a quantum energy in the ranges stated above. In particular, the secondary radiation generated is X-ray radiation.

In particular, the laser pulses of the pulse sequence have a wavelength between 300 nm and 10 μm. Preferably, the wavelength is in a range between 330 nm and 350 nm, between 500 nm and 550 nm, between 0.8 μm and 1.2 μm, between 1.5 μm and 2.5 μm, or between 9 μm and 11 μm. In particular, all laser pulses in the pulse sequence have the same wavelength.

It can be advantageous if the pulse duration of the prepulse is between 800 fs and 1.5 ps. This allows for the effective generation of nanoparticles, which in turn enables the interaction or absorption of the main pulse on the target material with a particularly high degree of efficiency.

For the same reason, it can be advantageous if the pulse energy of the prepulse is between 5 μJ and 100 μJ.

For the same reason, it can be favorable if the pulse time interval between the prepulse and the main pulse is between 10 ps and 100 ps.

In particular, the application of the prepulse to the target material causes nanoparticles to be formed. In particular, the nanoparticles are positioned in the region of a surface and/or in a spatial region of the target material in which the application of the prepulse to the target material occurs.

In particular, the surface forms a boundary surface and/or phase boundary of the target material.

In particular, the region in which the nanoparticles are positioned extends from the surface of the target material to a distance of 50 μm from the surface.

It can be advantageous if the pulse energy of the main pulse is between 5 mJ and 15 mJ and in particular between 8 mJ and 12 mJ. This allows secondary radiation in the form of X-rays, for example, to be generated with a particularly high degree of efficiency.

For the same reason, it can be advantageous if the pulse duration of the main pulse is between 25 fs and 50 fs.

In particular, all laser pulses of the pulse sequence can be applied to the target material at the same location and/or in the same spatial region of the target material. This results in the aforementioned increase in efficiency with respect to generating secondary radiation.

In particular, the spatial region in which the laser pulses of the pulse sequence strike the target material has a maximum spatial extent, in particular a maximum diameter, of at least 2.5 μm and/or at most 30 μm and in particular at least 3 μm and/or at most 15 μm.

In particular, the laser pulses of the pulse sequence travel towards the target material at a speed that is much greater than a speed of movement and/or flow speed of the target material within the target region so that all laser pulses of the pulse sequence strike the target material approximately at the same location and/or in the same spatial region.

In particular, the main pulse is applied to the target material in a spatial region and/or in the same spatial region in which nanoparticles were formed by means of the prepulse. In particular, the main pulse then strikes the nanoparticles formed in this spatial region and interacts with them.

An impact position of the respective laser pulses of the pulse sequence on the target material can be readjusted so that all laser pulses of the pulse sequence strike the target material at the same location and/or in the same spatial region. A control device can be provided for this purpose, for example.

For example, the impact position is readjusted such that the main pulse strikes the indentation formed on the surface of the target material, which was formed there by means of the pulse train made up of at least two prepulses.

It can be favorable if a negative pressure and/or a vacuum and/or a gas atmosphere with a defined composition is formed in the target region.

In particular, the laser pulses of the pulse sequence can be assigned to at least one primary laser beam, wherein the at least one primary laser beam is provided by means of a laser device and is directed at the target region in order to interact there with the target material. At least one primary laser beam is used to apply the laser pulses of the pulse sequence to the target material.

In particular, a single primary laser beam can be provided, to which the laser pulses of the pulse sequence are assigned. For example, this primary laser beam is then formed by means of coaxial superimposing of multiple laser beams, each of which provides one or more laser pulses of the pulse sequence.

In principle, it is also possible that multiple primary laser beams directed at the target region are provided in order to interact with the target material in the target region. In particular, the primary laser beams then extend at a distance from one another and/or enter the target region from different directions. The different primary laser beams are then, in particular, assigned one or more laser pulses of the pulse sequence in each case.

In particular, the at least one primary laser beam can be focused into the target region, wherein a focus of the primary laser beam is positioned in the target material and/or on the target material and/or in a region of the target material. The highest possible radiation intensity can be provided in the focus, which can be brought into interaction with the target material.

The focus of the at least one primary laser beam, in particular, has a diameter in the range of 2.5 μm to 30 μm and preferably in the range of 3 μm to 15 μm.

The target material is preferably in a liquid state. In particular, the target material is or comprises a low melting point metal. For example, the target material is or comprises gallium, indium, tin, zinc, lithium, bismuth or lead, or an alloy consisting of one or more of the aforementioned materials.

It can be advantageous if target material is continuously fed and/or conveyed into the target region. This means that fresh target material is continuously available in the target region, which can be brought into interaction with the pulse sequence for generating secondary radiation. This allows secondary radiation to be generated continuously.

In particular, the target material passes through the target region as a material stream and in particular as a liquid material stream. In particular, the target material passes through the target region at a specific speed and/or conveying rate.

The material stream can be formed as continuous, e.g. in the form of a jet, or have interruptions, e.g. in the form of successive drops.

One flow direction of the material stream is oriented in particular parallel to the direction of gravity. In particular, the flow direction is oriented transverse or perpendicular to the direction of movement of the laser pulses of the pulse sequence and/or oriented perpendicular to the direction of propagation of at least one primary laser beam to which the laser pulses of the pulse sequence are assigned.

For example, a flow speed of the target material in the target region oriented parallel to the flow direction is between 60 m/s and 120 m/s.

It can be favorable if the pulse sequence made up of laser pulses is repeatedly provided anew and introduced into the target region, wherein a newly provided pulse sequence made up of laser pulses is applied to the target material newly introduced into the target region in each case. This allows secondary radiation to be generated continuously.

In particular, the pulse sequence made up of laser pulses is provided again at intervals and, in particular, at regular intervals.

According to embodiments of the invention, the laser system mentioned at the outset comprises a laser device which is designed to provide a pulse sequence made up of laser pulses, wherein the pulse sequence has a prepulse and a main pulse trailing the prepulse, a pulse energy of the prepulse is between 2 μJ und 200 μJ and a pulse duration of the prepulse is between 200 fs and 5 ps, a pulse energy of the main pulse is between 2 mJ and 50 mJ and a pulse duration of the main pulse is between 15 fs and 300 fs and wherein a pulse time interval between the prepulse and the main pulse is between 1 ps and 1 ns, wherein the laser system is designed to apply the pulse sequence made up of laser pulses to a target material in a target region, wherein interaction of the target material with the pulse sequence generates secondary radiation.

In particular, the laser system according to embodiments of the invention has one or more further features and/or advantages of the method according to embodiments of the invention. Advantageous embodiments of the laser system have already been explained in connection with the method.

The method according to embodiments of the invention can be carried out in particular by means of the laser system according to embodiments of the invention. In particular, the method according to embodiments of the invention is carried out by means of the laser system according to embodiments of the invention.

In particular, at least one primary laser beam is provided by means of the laser device, to which the laser pulses of the pulse sequence are assigned, wherein the at least one primary laser beam is directed at the target material located in the target region. The at least one primary laser beam has the laser pulses of the pulse sequence which are applied to the target material.

In particular, the laser device comprises one or more laser sources for providing the laser pulses of the pulse sequence. For example, a primary laser beam with laser pulses of a determined type and/or certain characteristics is provided in each case by means of a respective laser source.

In particular, the respective primary laser beams, which are provided by different laser beam sources, are superimposed and in particular coaxially superimposed to form a resulting primary laser beam, wherein the laser pulses of the pulse sequence are assigned to the resulting primary laser beam.

In particular, the laser system comprises a focusing optical unit for focusing the at least one primary laser beam into a focus, wherein the focus is positioned in the target region in the target material and/or on the target material and/or in a region of the target material.

In particular, the laser system can have a control device for controlling and/or regulating a beam length of the at least one primary laser beam. Preferably, the control device is designed to control or regulate a position of the at least one primary laser beam and, in particular, its focus within the target region and/or an impact position of the primary laser beam on the target material within the target region.

In particular, the laser system can comprise the target region and/or the target material.

In the context of the present application documents, diameters of laser beams and/or focus diameters are generally defined using the method of second-order moments according to ISO 11146-3. Pulse durations are defined in particular by the half-width of the unfolded autocorrelation.

In particular, the wording “at least approximately” is generally understood to mean a deviation of at most 10%, i.e., that an actual value deviates by at most 10% from an ideal value.

Elements that are the same or have equivalent functions are provided with the same reference signs in all of the figures.

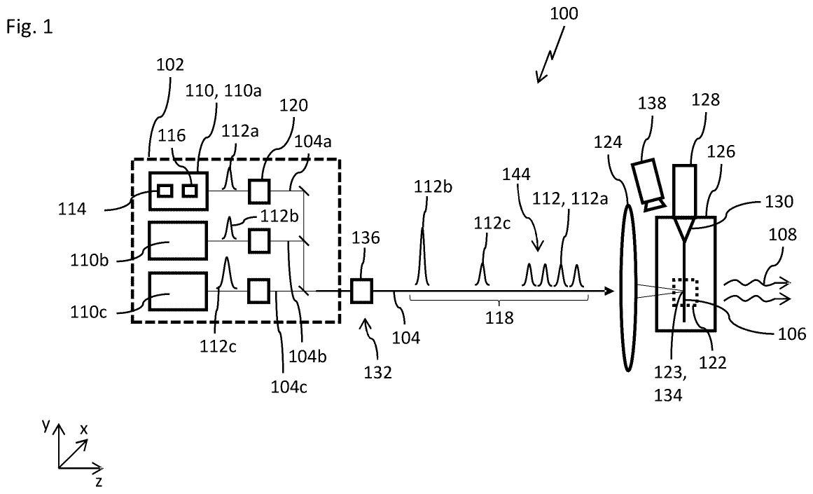

An exemplary embodiment of a laser system is shown in FIG. 1, where it is designated with 100. The laser system 100 comprises a laser device 102 by means of which at least one pulsed primary laser beam 104 is provided during operation of the laser system 100. This primary laser beam 104 is directed at a target material 106, wherein secondary radiation 108 is generated by interaction of the primary laser beam 104 with the target material 106.

The target material 106 is or comprises, for example, gallium, indium, tin, zinc, lithium, bismuth or alloys of these metals.

The laser device 102 is designed to provide the pulsed primary laser beam 104 with laser pulses 112 having different characteristics and pulse intervals. To this end, the laser device 102 comprises, for example, multiple laser sources 110, each of which generates pulsed laser beams with different characteristics. In the example shown, the respective pulsed laser beams from these laser sources 110 are coaxially superimposed in order to form the pulsed primary laser beam 104 emerging from the laser device 102.

For example, the laser device 102 comprises a first laser source 110a which provides a first pulsed primary laser beam 104a with laser pulses 112a, a second laser source 110b which provides a second pulsed primary laser beam 104b with laser pulses 112b, and a third laser source 110c which provides a third pulsed primary laser beam 104c with laser pulses 112c.

The first primary laser beam 104a, second primary laser beam 104b and third primary laser beam 104c emerging from the laser device 102 are coaxially superimposed in the example shown and, in particular, have the same beam path after emerging from the laser device 102. In the example shown, the primary laser beam 104 is thus formed from the first primary laser beam 104a, second primary laser beam 104b and third primary laser beam 104c or comprises the first primary laser beam 104a, second primary laser beam 104b and third primary laser beam 104c.

Alternatively, it is also possible in principle for the different primary laser beams 104a, 104b, 104c to have different beam paths after emerging from the laser device 102 and/or to extend at a distance from one another before they strike the target material 106. In this case, in particular, there is no coaxial superimposing of the different primary laser beams 104a, 104b, 104c.

A respective laser source 110 comprises, for example, a seed laser 114 for generating seed laser pulses and an amplification device 116 which generates the respective laser pulses 112a, 112b, 112c of the primary laser beams 104a, 104b, 104c by amplifying the seed laser pulses (indicated for the laser source 110a in FIG. 1).

The amplification device 116 can comprise simple amplifiers, regenerative amplifiers, and/or multipass amplifiers. For example, the amplification device 116 can have fiber, rod, rod-type fiber, disc, slab, multi-slab, and/or plate amplifiers.

Alternatively, it is also possible, for example, that a common amplification device 116 is assigned to multiple or all laser sources 110 present. In particular, multiple or all laser sources 110 then use the same amplification device 116. In this case, for example, the laser pulses generated by different seed lasers 114 of the laser sources 110 are amplified by means of the same amplification device 116 in order to form the respective laser pulses 112a, 112b, 112c of the primary laser beams 104a, 104b, 104c.

The laser device 102 is designed to couple out the laser pulses 112 provided by the different laser sources 110 with a defined temporal sequence and/or a defined temporal offset, in order to apply the laser pulses 112 to the target material 106 in this temporal sequence or with this defined temporal offset. These laser pulses 112 form a pulse sequence 118 which is applied to the target material 106 for generating secondary radiation 108.

For example, the laser beam assigned to the laser pulses 112 has a wavelength of, for example, 10 μm, 3 μm, 515 nm or 343 nm.

In order to couple out the laser pulses 112 provided by the different laser sources 110 with a defined temporal sequence and/or defined temporal offset, the laser device 102 can comprise one or more optical modulators 120 and/or optical switches. For example, a modulator 120 is assigned to each of the different laser sources 110 of the laser device 102. By means of the respective modulator 120, laser pulses 112 are selected for coupling out of the laser device 102 during operation of the laser system 100 and/or time intervals between the coupled-out laser pulses are adjusted.

For example, the optical modulator 120 can be designed as an acousto-optical modulator and/or an electro-optical modulator.

For example, as shown in FIG. 1, the modulators 120 are each arranged downstream of a specific laser beam source 110. In principle, it is also possible that the modulators 120 are each integrated into a specific laser beam source 110 and are arranged there, for example, between the seed laser 114 and the amplifier 116.

Alternatively or additionally, a specific temporal sequence and/or a specific temporal offset between the coupled-out laser pulses 112 can be realized by means of a defined path length difference and/or propagation time difference, which the individual laser pulses 112 have relative to one another when originating from the respective laser source 110 until they reach the target material 106. The provision of the path length difference can be realized, for example, via electronic and/or optical delay sections (not shown), wherein a delay section can be inserted into the respective beam path of one or more of the present primary laser beams 104a, 104b, 104c. Optical delay sections can generally be designed as free-beam-based or fiber-based.

The laser system 100 has a target region 122 in which the target material 106 is arranged in order to apply the primary laser beam 104 to it and bring it into interaction with its laser pulses 112. Here, it is essential that target material 106 is continuously fed into the target region 122 so that fresh target material 106, which the primary laser beam 104 in particular has not yet been applied to, is always available for generating secondary radiation 108. This allows for the continuous generation of secondary radiation 108 during operation of the laser system 100.

In particular, the pulsed primary laser beam 104 directed at the target material 106 is focused into a focus 123, wherein the focus 123 is arranged in the target region 122 in and/or on the target material 106. For example, a focusing optical unit 124 can be provided for this purpose.

The target region 122 is to be understood as a stationary region of the laser system 100 into which the target material 106 is coupled and/or into which the primary laser beam 104 is introduced in order to interact with the target material 106.

The target region 122 is preferably positioned in a fluid-tight and/or gas-tight chamber 126. In this chamber 126, for example, a negative pressure and/or a vacuum and/or a gas atmosphere with a defined composition is formed in comparison with the surrounding environment. For example, the pressure inside of the chamber is between 10 mbar and 500 mbar.

For example, the gas disposed in the chamber 126 is or comprises hydrogen and/or helium.

In order to feed the target material 106 into the target region 122 and convey it through the target region 122, the laser system 100 can have a feeding device 128. In particular, the feeding device 128 can be used to continuously provide target material 106, which passes through the target region 122 at a specific speed and/or conveying rate.

In particular, the target material 106 is provided by means of the feeding device 126 as a liquid material stream which passes through the target region 122. This material stream is preferably provided in the form of a jet and in particular in the form of a continuous and/or uninterrupted jet. However, the material stream can also be provided in the form of successive and/or spaced apart droplets. The feeding device 126 has, for example, a nozzle 128 by means of which the target material 106 is dispensed accordingly.

In the example shown in FIG. 1, the direction of gravity is oriented in the negative y-direction so that target material 106 dispensed by the feeding device 126 passes through the target region 122 in the direction of gravity (i.e., in the negative y-direction or from top to bottom).

For example, the target material 106 passes through the target region 122 at a speed between 60 m/s and 120 m/s.

In principle, it is also possible that the liquid material stream of the target material 106 provided by means of the feeding device 126 is present as a film which is formed on a suitable material surface (not shown) and passes through the target region 122. To this end, the feeding device 126 can comprise, for example, a movable mechanism (not shown), such as a rotating wheel, a rotating drum, a rotating ball or a moving belt, on the surface of which the film is formed.

Further technical details concerning the provision of target material for generating secondary radiation through interaction with a primary laser beam are described, for example, in the scientific publication “Light sources for high-volume manufacturing EUV lithography: technology, performance, and power scaling”, I. Fomenkov et al., Advanced Optical Technologies 6(3):173-186, DOI: 10.1515/aot-2017-0029.

The laser system 100 can have a control device 132 for controlling and/or regulating a beam length of the primary laser beam 104. This control device 132 is designed in particular to control or regulate a position of the primary laser beam 104 and, in particular, its focus 123 within the target region 122 and/or an impact position 134 of the primary laser beam 104 on the target material 106 within the target region 122.

In order to spatially displace the primary laser beam 104, the control device 132 comprises a beam deflection device 136. This device can, for example, have movable mirror elements, acousto-optical deflectors and/or electro-optical deflectors in order to achieve the displacement.

Furthermore, the control device 132 can have a detection device 138 that is designed to detect a local position of a specific feature, wherein the feature is arranged or formed on or in the region of the target material 106. For example, the feature is a geometric feature formed on the target material 106, such as an indentation (see below). For detecting a specific feature, the detection device 138 can comprise a camera used to detect the feature, for example by means of image recognition.

The beam deflection device 136 is then designed to control and/or regulate the displacement of the primary laser beam 104 by means of the beam deflection device 136 based on the information provided by the detection device 138. For this purpose, the detection device 138 is connected to the beam deflection device 136 in a signal-effective manner.

The laser system 100 functions as follows:

During operation of the laser system 100, a pulse sequence 118 is provided by means of the laser device 102 and is brought to interact with target material 106 located in the target region 122 in order to generate secondary radiation 108.

The target material 106 is continuously conveyed into the target region 106 by means of the feeding device 128 so that fresh target material 106 is always available there, which passes through the target region 122, in particular in the form of a liquid jet (in the examples shown, the target material 106 passes through the target region 122 parallel to the direction of gravity or in the negative y-direction).

A defined pulse sequence 118 is applied to a specific spatial region of the target material 106 conveyed through the target region 122 in each case. The target material 106 interacts in particular with all laser pulses 112 of the pulse sequence 118 in this spatial region. Subsequently, a further pulse sequence 118 is emitted by the laser device 102, in particular, which is then brought into interaction with a further spatial region of subsequently conveyed target material 106, and so on. In this way, the process for generating the secondary radiation 106 can be continued continuously.

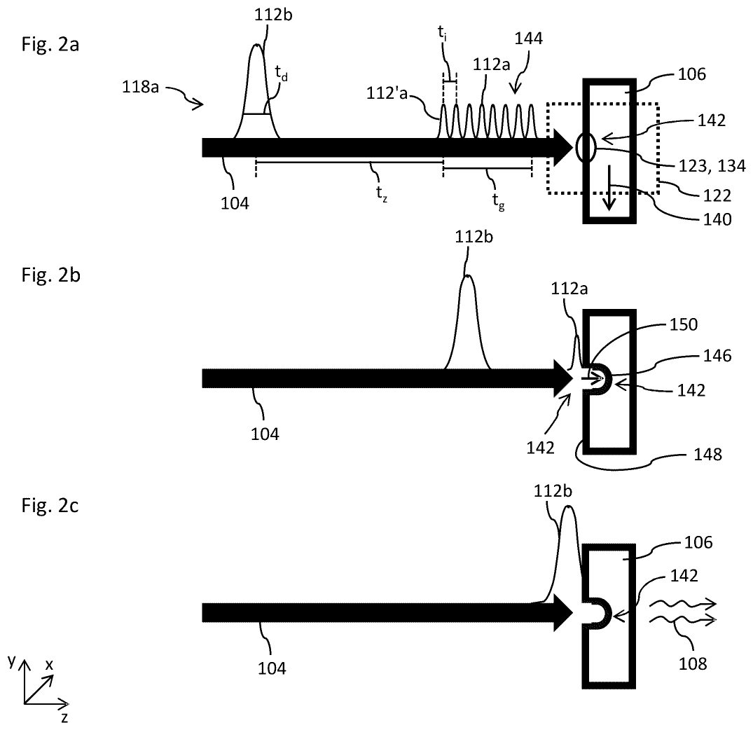

FIGS. 2a to 2c show a temporal sequence of laser pulses 112a, 112b striking the target material 106, which are assigned to a pulse sequence 118a. In the representation shown, the target material 106 flows through the target region 122 parallel to a flow direction 140.

The primary laser beam 104 having the laser pulses 112a, 112b or its focus 123 strikes the target material 106 in a specific spatial region 142. This spatial region 142 is to be understood as a spatial region that is stationary with respect to the target material 106, is assigned to the target material 106 and moves with the target material 106 in the flow direction.

The pulse sequence 118a comprises a pulse train 144 made up of two or more first laser pulses 112a and a further laser pulse 112b trailing the pulse train 144. The first laser pulses 112a are also referred to here as prepulses and the further laser pulse 112b as the main pulse of the pulse sequence 118a.

In particular, the focus 123 of the primary laser beam 104 has a diameter in the range of 2.5 μm to 30 μm. An intensity of the primary laser beam 104 at the focus 123 in the case of the main pulse 112b is in particular between 10¹⁶ W/cm² and 1019 W/cm².

The first laser pulses 112a are thus to be understood as laser pulses 112 of a first type and/or with first pulse characteristics, and the second laser pulses 112b are to be understood as laser pulses of a second type and/or with second pulse characteristics. Accordingly, the third laser pulses 112c are to be understood as laser pulses 112 of a third type and/or with third pulse characteristics.

The pulse train 144 is to be understood in particular as a “burst” made up of first laser pulses 112a. In particular, the pulse train 144 has at least two and in particular at least 20 and in particular at least 100 first laser pulses 112a.

A pulse time interval tᵢ between successive first laser pulses 112a within the pulse train 144 is between 100 ps and 100 ns, and preferably between 200 ps and 0.5 ns. In particular, the pulse time interval tᵢ between all present neighboring first laser pulses 112a of the pulse train 144 is at least approximately equal.

A total time length t_{g} of the pulse train 144 made up of first laser pulses 112a is between 1 ns and 10 μs.

A total energy of the pulse train 144 is, for example, between 0.8 mJ and 1.2 mJ. The total energy of the pulse train 144 is understood to be the sum of the pulse energies of all first laser pulses 112a assigned to the pulse train 144. In particular, all of the first laser pulses 112a assigned to the pulse train 144 have at least approximately the same pulse energy.

A pulse time interval t_{z} between the pulse train 144 and the second laser pulse 112b is between 10 ps and 1 μs. The pulse time interval t_{z} is understood to be the time interval between a last first laser pulse 112′a of the pulse train 144 and the second laser pulse 112b.

The second laser pulse 112b trails the pulse train 144, i.e., the first laser pulses 112a of the pulse train 144 strike the target material 106 first, followed by the second laser pulse 112b.

A pulse duration t_{d} of the second laser pulse 112b is, for example, between 25 fs and 50 fs.

A pulse energy of the second laser pulse 112b is, for example, between 8 mJ and 12 mJ.

The first laser pulses 112a are provided, for example, by means of the first laser source 110a. The first laser source 110a is then designed to provide first laser pulses 112a having the aforementioned characteristics. Accordingly, the second laser pulses 112b are provided, for example, by means of the second laser source 110b, which is then designed to provide second laser pulses 112b having the aforementioned characteristics. The pulse sequence 118a described above, which comprises the first and second laser pulses 112a and 112b respectively, can be formed using the optical modulators 120, for example. For this purpose, the optical modulators 120 are used, for example, as “pulse pickers” and select the laser pulses provided by the respective laser sources 110a, 110b to form the pulse sequence 118a accordingly.

FIG. 2b shows the target material 106 after interaction of multiple first laser pulses 112a of the pulse train 144, i.e., the pulse sequence 118a has already been partially brought into interaction with the target material 106 and/or absorbed by the target material 106.

The interaction of the pulse train 144 made up of first laser pulses 112a or prepulses causes the formation of an indentation 146 in the target material 106, wherein this indentation is positioned in that region 142 of the target material 106 in which the interaction with the first laser pulses 112a has occurred. The indentation 146 is formed in particular as a “cup” or “dimple”. In principle, it is also possible for the indentation 146 to be formed in the shape of a torus and/or annular trench.

The formation of indentations in materials through their interaction with laser pulses and the underlying physical effects are described, for example, in the scientific publication “Review on Experimental and Theoretical Investigations of Ultra-Short Pulsed Laser Ablation of Metals with Burst Pulses” by Förster et al., Materials 2021, 14, 3331, https://doi.org/10.3390/ma14123331.

In particular, the interaction of the first laser pulses 112a of the pulse train 114 causes material ablation by vaporization and/or melting.

The indentation 146 is formed on a surface 148 and/or outer side of the target material 106 which the primary laser beam 104 or its laser pulses 112a, 112b strike. In particular, this surface 148 forms a boundary surface of the target material 106, which in the examples shown is present as a liquid material stream in the form of a jet.

A depth direction 150 of the indentation 146 is oriented at least approximately parallel to the propagation direction of the primary laser beam 104 (indicated by the arrow of the primary laser beam 104) and/or at least approximately perpendicular to the flow direction 140 of the target material 106.

A maximum depth of the indentation 146 oriented parallel to the depth direction 150 with respect to the surrounding surface 148 is, for example, between 5 μm and 150 μm, in particular between 10 μm and 50 μm. A maximum spatial extent and/or a maximum diameter of the indentation 146 is, for example, between 5 μm and 30 μm.

FIG. 2c shows the interaction of the second laser pulse 112b or main pulse with the target material 106 at the indentation 146 formed. This interaction generates secondary radiation 108, wherein the generation of secondary radiation can be achieved in a particularly efficient manner due to the indentation 146 formed. In particular, the indentation is formed in a conical and/or parabolic shape.

This is due in particular to the improved absorption of the main pulse caused by the indentation 146, as described, for example, in the scientific publication “Enhancement of hard x-ray emission from a copper target by multiple shots of femtosecond laser pulses” by Hironaka et al., Applied Physics Letters, Volume 74, Number 12, Mar. 22, 1999. In particular, a reduced Fresnel reflection can occur, which contributes to the improved absorption.

Furthermore, the geometric shape of the indentation 146 can result in a concentration of the radiation intensity of the incident main pulse, which is described, for example, in the scientific publication “Development of a bright MeV photon source with compound parabolic concentrator targets on the National Ignition Facility Radiographic Capability (NIF-ARC) laser” by Kerr et al, Phys. Plasmas 30, 013101 (2023), https://doi.org/10.1063/5.0124539.

In principle, it is possible that the pulse sequence 118a has multiple second laser pulses 112b in order to generate secondary radiation 108.

Subsequently, to continue the method, a further pulse sequence 118a is generated, which is brought into interaction with a new spatial region of subsequently conveyed target material 106, and so on. In this way, secondary radiation 108 is continuously generated.

In the method shown in FIGS. 2a, 2b and 2c, all laser pulses 112a, 112b of the respective pulse sequence 118a interact with the target material 106 in the same spatial region 142. In particular, the first laser pulses 112a of the pulse train 144 interact with the target material 106 in the same spatial region 142 as the second laser pulse 112b. This second laser pulse 112b interacts with the target material 106 in the spatial region 142 in which the indentation 146 is formed.

In particular, a speed of movement of the laser pulses 112a, 112b in the direction of the target material 106 is much greater than its flow speed so that all laser pulses interact with the target material 106 approximately in the same spatial region 142.

The control device 132 can be used to readjust the impact position 134 of the primary laser beam 104 on the target material 106 so that this remains constant, in particular between the formation of the indentation 146 and the impact of the second laser pulse 112b. For this purpose, for example, a spatial position of the indentation 146 formed is determined by means of the detection device 138 and, based on this, the beam position of the primary laser beam 104 is adjusted by means of the beam deflection device 136.

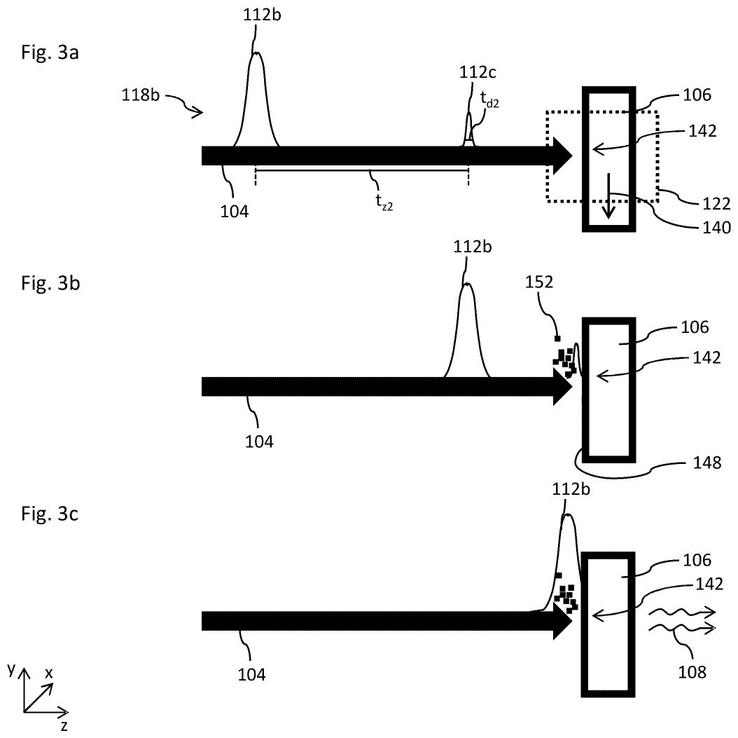

In the example shown in FIGS. 3a to 3c, a pulse sequence 118b is applied to the target material 106, which has a third laser pulse 112c and a second laser pulse 112b trailing the third laser pulse 112c.

A pulse duration t_{d2} of the third laser pulse 112c is, for example, between 800 fs and 1.5 ps.

For example, a pulse energy of the third laser pulse 112c is between 10 μJ and 20 μJ.

A pulse time interval t_{z2} between the third laser pulse 112c and the second laser pulse 112b is, for example, between 10 ps and 100 ps.

The provision of third laser pulses 112c is carried out, for example, by means of the third laser source 110c. The third laser source 110c is then designed to provide third laser pulses 112c having the aforementioned characteristics.

The second laser pulse 112b has the characteristics mentioned above in connection with the example according to FIGS. 2a to 2c. In principle, it is possible that the pulse sequence 118b has multiple second laser pulses 112b.

The interaction of the third laser pulse 112c with the target material 106 causes nanoparticles 152 to be formed on the surface 148 of the target material 106, wherein the nanoparticles 152 are positioned in that spatial region 142 on the surface 148 in which an application of the primary laser beam 104 to the target material 106 and an interaction of the target material 106 with the third laser pulse 112c occurs.

In the present example, the third laser pulse 112c is referred to as the prepulse and the second laser pulse 112b is referred to as the main pulse of the pulse sequence 118b.

The formation of nanoparticles in the region of materials through their interaction with laser pulses and the underlying physical effects are described, for example, in the scientific publication already mentioned above “Review on Experimental and Theoretical Investigations of Ultra-Short Pulsed Laser Ablation of Metals with Burst Pulses” by Forster et al. and in the scientific publication “Fs-ns double-pulse Laser Induced Breakdown Spectroscopy of copper-based-alloys: Generation and elemental analysis of nanoparticles” by Guarnaccio et al., Spectrochimica Acta Part B 101 (2014) 261-268, https://doi.org/10.1016/j.sab.2014.09.011.

An average diameter of the nanoparticles 152 is between 10 nm and 100 nm.

It is also possible that multiple third laser pulses 112c are provided for generating the nanoparticles 152, or that a pulse train made up of multiple third laser pulses 112c is provided.

FIG. 3c shows the interaction of the second laser pulse 112b with the target material 106 in the spatial region 142 of the formed nanoparticles 152, wherein secondary radiation 108 is generated by this interaction. Due to the nanoparticles 152 present, secondary radiation 108 can be generated particularly efficiently using the second laser pulse 112b.

Due to the presence of the nanoparticles 152 in the region of the surface 148 of the target material 106, so-called plasmonic resonances can occur, which cause a particularly good absorption of the radiation of the main pulse in the electron gas of the target material 106 and, in particular, a particularly efficient increase in the electron temperature in the electron gas.

Analogous to the example according to FIGS. 2a to 2c, a speed of movement of the laser pulses 112c, 112b in the direction of the target material 106 is much greater than its flow speed so that all laser pulses interact with the target material 106 approximately in the same spatial region 142.

In this example, the control device 132 can be used to readjust the impact position 134 of the primary laser beam 104 on the target material 106 so that it remains constant, in particular between the formation of the nanoparticles 152 and the impact of the second laser pulse 112b. For this purpose, for example, a spatial position of the formed nanoparticles 152 is determined by means of the detection device 138 and, based on this, the beam position of the primary laser beam 104 is adjusted by means of the beam deflection device 136.

It is possible to combine the variants described in FIGS. 2a to 2c and 3a to 3c. In particular, the pulse sequence 118 is then formed such that its interaction with the target material 106 first generates an indentation 146 in a specific spatial region 142 and then nanoparticles 152 are generated in this spatial region 142. Subsequently, the secondary radiation 108 is generated by interaction of a main pulse in this region 142.

In this case, the pulse sequence 114 comprises, for example, the pulse train 144 made up of first laser pulses 112a described above, the third laser pulse 112c described above (cf. FIG. 1) or a pulse train made up of third laser pulses 112c and the second laser pulse 112b described above. The pulse train 144 made up of first laser pulses 112a is arranged temporally prior to the third laser pulse 112c or the pulse train made up of third laser pulses 112c and the third laser pulse 112c or the pulse train made up of third laser pulses 112c is arranged temporally prior to the second laser pulse (i.e., the pulse train 144 made up of first laser pulses 112a strikes the target material 106 first, then the third laser pulse 112c or the pulse train made up of third laser pulses 112c and finally the second laser pulse 112b). A time interval between the pulse train 144 made up of first laser pulses 112a, the third laser pulse 112c or pulse train made up of third laser pulses 112c and the second laser pulse 112b is in particular between 1 ps and 500 ns in each case.

By means of the methods described, incoherent X-ray radiation in particular can be generated particularly efficiently as secondary radiation 108.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

t_{d} Pulse duration
t_{d2} Pulse duration
t_{g} Total time length
tᵢ Pulse time interval
t_{z} Pulse time interval
t_{z2} Pulse time interval
102 Laser device
104 Primary laser beam
104a First primary laser beam
104b Second primary laser beam
104c Third primary laser beam
106 Target material
108 Secondary radiation
110 Laser source
110a First laser source
110b Second laser source
110c Third laser source
112 Laser pulse
112a, c Laser pulse/prepulse
112′a Laser pulse/prepulse
112b Laser pulse/main pulse
114 Seed laser
116 Amplification device
118 Pulse sequence
118a, b Pulse sequence
120 Optical modulator
122 Target region
123 Focus
124 Focusing optical unit
126 Chamber
128 Feeding device
130 Nozzle
132 Control device
134 Impact position
136 Beam deflection device
138 Detection device
140 Flow direction
142 Spatial region
144 Pulse train
146 Indentation
148 Surface
150 Depth direction
152 Nanoparticles

1. A method for generating secondary radiation, the method comprising:
providing a target material in a target region, and
applying a pulse sequence comprising laser pulses to the target material in the target region, wherein interaction of the target material with the pulse sequence generates secondary radiation, wherein
the pulse sequence comprises a prepulse and a main pulse trailing the prepulse,
a pulse energy of the prepulse is between 2 μJ und 200 μJ, and a pulse duration of the prepulse is between 200 fs and 5 ps,
a pulse energy of the main pulse is between 2 mJ and 50 mJ, and a pulse duration of the main pulse is between 15 fs and 300 fs, and
a pulse time interval between the prepulse and the main pulse is between 1 ps and 1 ns.

2. The method according to claim 1, wherein the pulse duration of the prepulse is between 800 fs and 1.5 ps, and/or the pulse energy of the prepulse is between 5 μJ and 100 μJ.

3. The method according to claim 1, wherein the pulse time interval between the prepulse and the main pulse is between 10 ps and 100 ps.

4. The method according to claim 1, wherein application of the prepulse to the target material causes nanoparticles to be formed, wherein the nanoparticles are positioned in a region of a surface and/or in a spatial region of the target material in which the application of the prepulse to the target material occurs.

5. The method according to claim 1, wherein the pulse energy of the main pulse is between 5 mJ and 15 mJ, and/or the pulse duration of the main pulse is between 25 fs and 50 fs.

6. The method according to claim 1, wherein application of all laser pulses of the pulse sequence to the target material occurs at a same location and/or in a same spatial region of the target material, and/or application of the main pulse to the target material occurs in a spatial region in which nanoparticles are formed by the prepulse.

7. The method according to claim 1, wherein a negative pressure and/or a vacuum and/or a gas atmosphere with a defined composition is formed in the target region.

8. The method according to claim 1, wherein the laser pulses of the pulse sequence are applied via at least one primary laser beam, wherein the at least one primary laser beam is provided by a laser device and is directed at the target region in order to interact with the target material.

9. The method according to claim 8, wherein the at least one primary laser beam is focused into the target region, wherein a focus of the primary laser beam is positioned in the target material and/or on the target material and/or in a region of the target material.

10. The method according to claim 1, wherein the target material is continuously fed and/or conveyed into the target region.

11. The method according to claim 10, wherein the target material passes through the target region as a material stream, and/or the target material passes through the target region at a specific flow speed and/or a conveying rate.

12. The method according to claim 10, wherein the pulse sequence of laser pulses is repeatedly provided anew and introduced into the target region, wherein a newly provided pulse sequence of laser pulses is applied to the target material newly introduced into the target region.

13. A laser system for generating secondary radiation, the laser system comprising:
a laser device configured to provide a pulse sequence comprising laser pulses, wherein
the pulse sequence has a prepulse and a main pulse trailing the prepulse,
a pulse energy of the prepulse is between 2 μJ und 200 μJ, and a pulse duration of the prepulse is between 200 fs and 5 ps,
a pulse energy of the main pulse is between 2 mJ and 50 mJ, and a pulse duration of the main pulse is between 15 fs and 300 fs, and
a pulse time interval between the prepulse and the main pulse is between 1 ps and 1 ns,
wherein the laser system is configured to apply the pulse sequence of laser pulses to a target material in a target region, wherein interaction of the target material with the pulse sequence generates secondary radiation.
